(19) United States
(12) Patent Application Publication
(10) Pub. No.: US 2007/0298873 A1
(43) Pub. Date: Dec. 27, 2007

(54) PROGRESSIVE TABLE GAME BONUSING SYSTEMS AND METHODS

(75) Inventors: Binh T. Nguyen, Reno, NV (US); Richard E. Michaelson, Reno, NV (US); Craig A. Paulsen, Reno, NV (US); Jay Roper, Las Vegas, NV (US)

Correspondence Address: BEYER WEAVER LLP, P.O. BOX 70250, OAKLAND, CA, 94612-0250, US

(73) Assignee: IGT, Reno, NV (US)

(21) Appl. No.: 11/425,998

(22) Filed: Jun. 22, 2006

(51) Int. Cl. G06F 19/00

(52) U.S. Cl. 463/27

(57) ABSTRACT

Systems and methods using multiple gaming tables, tracking devices and a bonus server adapted to provide progressive bonuses are provided. The bonus server provides eligibility to a singular progressive table game bonus simultaneously to multiple table game players at multiple gaming tables of multiple gaming table types. Funding and player eligibility for the progressive table game bonus are based on main wagers made on main table games, with separate bonus side wagers or funding not being needed. The bonus server or system can determine all patrons eligible for the bonus, track wagering information, award an appropriate number of entries to the bonus for each eligible player, and determine a bonus outcome based on the number of entries. The number of entries awarded to a given player can be weighted based on the size of a wager and its associated expectation value to the gaming operator.

### TECHNICAL FIELD

The present invention relates generally to table games within a gaming environment, and more specifically to various bonus awards for use in conjunction with such table games.

### BACKGROUND

Casinos and other forms of gaming comprise a growing multi-billion dollar industry both domestically and abroad, with electronic and microprocessor based gaming machines being more popular than ever. While such gaming machines have become a staple for many casinos and gaming establishments, table games remain an immensely popular form of gaming and a substantial source of revenue for gaming operators as well. Such table games are well known and can include, for example, poker, blackjack, baccarat, craps, roulette and other traditional standbys, as well as other more recently introduced games such as pai-gow, Carribean Stud, Spanish 21, and Let It Ride, among others.

Under a typical gaming event at a gaming table, a player places a wager on a game, whereupon a winning may be paid to the player depending on the outcome of the game. As is generally known, a wager may involve the use of cash or one or more chips, markers or the like, as well as various forms of gestures or oral claims. The game itself may involve the use of, for example, one or more cards, dice, wheels, balls, tokens or the like, with the rules of the game and any payouts or pay tables being established prior to game play. As is also known, possible winnings may be paid in cash, credit, one or more chips, markers, or prizes, or by other forms of payouts. In addition to table games, other games within a casino or other gaming environment are also widely known. For instance, keno, bingo, sports books, and ticket drawings, among others, are all examples of wager based games and other events that patrons may partake of within a casino or other gaming establishment.

One way of generating extra interest and excitement for patrons of a casino is to provide bonuses or secondary games to those who play games involving the placement of a wager and possible monetary payout as a result. Such bonuses or secondary games generally tend to be in addition to any customary payout for a regular outcome of a main or primary game. As is generally known, bonusing or secondary games within a casino or other gaming environment tends to involve slot machines and other gaming machines for the most part, and there are generally a wide variety of such gaming machine bonuses. Various instances and descriptions of gaming machine bonuses can be found at, for example, U.S. Pat. Nos. 4,837,728; 5,851,148; 6,231,442; 6,336,863; 6,425,824; 6,960,134 and 6,984,174, U.S. Patent Application Publication Nos. 2005/0059472 and 2005/0059481, and Australian Patent Nos. 754,689 and 766,341, among many other varied references.

In contrast to the various bonusing and secondary games that are prevalent with respect to slots and other gaming machines, such items have traditionally not carried the same level of popularity with respect to table games. Although bonusing programs, secondary games or other similar schemes might be available with respect to some table games on occasion, such bonuses are typically limited in nature, such as to the specific table or genre of table games within the casino. In the event that bonuses may actually be provided for a table game or other alternative venues within a casino or other gaming establishment, such bonuses tend to be isolated and sporadic in nature. Furthermore, many table game bonuses require the placement of an extra separate wager by the player, which is viewed by many players to be undesirable and less favorable to the player than a regular wager on the main table game. Various instances and descriptions of such limited and/or isolated table machine bonuses can be found at, for example, U.S. Pat. Nos. 5,364,105; 5,288,077; 5,707,287; 5,743,798; and 5,605,334, among other varied references.

In fact, many forms of table games have traditionally had no form of bonus at all. For example, the game of roulette is typically an independent game within the casino, having no secondary game or bonus, and having no connection to any other casino game. Similarly, the game of craps also tends to have no secondary game or bonus, and also tends to be independent and without connection to any other game. Although such games surely have their place on the casino floor, such isolation can be a drawback for some games, particularly where casual players tend to flock to games that seem to be more popular, or at least tied to some general theme marketed by the casino. In particular, games that involve bonuses may tend to be more exciting or enticing to many casual gaming patrons. Further, the lack of a consistent theme or bonusing scheme from one type of game to the next, assuming such games have any type of bonusing scheme at all, may be detrimental from the point of view of some players. As such, these players may be less likely to try different games, or to even go to a casino with friends or family who do not play the same kinds of games that they do.

While existing systems and methods for providing bonuses within a casino environment have generally been adequate in the past, improvements are usually welcomed and encouraged. In light of the foregoing, it is desirable to develop systems and methods involving table game bonuses that are more attractive to players and potential players, and in particular for such systems and methods to include a progressive table game bonus that does not necessarily require any activity beyond regular table game play for players to be eligible for the bonus.

### SUMMARY

It is an advantage of the present invention to provide improved systems and methods relating to progressive bonusing for gaming tables within a casino environment. This is accomplished in many embodiments by providing within or about a casino or other gaming establishment a progressive table game bonusing system adapted to offer the same bonusing schemes or plans to many gaming tables simultaneously. In some embodiments, multiple gaming tables involving the play of disparate games may be included in the same progressive bonusing scheme. Further gaming venues, such as keno and sports books, may also be adapted to take part in the progressive table game bonusing systems and methods provided herein. In addition, multiple tables, pits, gaming establishments, and gaming establishments in different states and/or countries can be adapted to partake in the same progressive bonus.

According to several embodiments of the present invention, the disclosed systems and methods involve a gaming system adapted for providing progressive bonuses at gaming tables involving wager based games, such as poker, blackjack, baccarat, craps, roulette, pai-gow, Carribean Stud, Spanish 21, Let It Ride and the like. Such progressive table game bonusing systems can involve a singular bonus, as well as a series of different bonuses, either of which may be provided for from a common jackpot pool. Different bonuses can be provided on different levels, such as in a tiered fashion. Bonus tiers or levels can be on the order of a single table, a pit area, a casino, a wide area including multiple casinos, an entire region or state including a large number of casinos therein, and/or worldwide. Such progressive table game bonuses are preferably provided to patrons or players of table games based only on the main wagers placed by players with respect to those table games. By providing a singular progressive bonus that is made available simultaneously at disparate gaming tables and/or other gaming offerings across disparate venues and gaming establishments, it is anticipated that greater excitement and willingness to play table games amongst gaming players and patrons will be fostered.

According to several embodiments of the present invention, the disclosed systems and methods involve the provision of a plurality of gaming tables adapted for hosting gaming events involving wagers, the play of main table games based on the wagers and the grants of a monetary payouts based on the results of the main table games. Preferably, such gaming tables are adapted to host disparate types of main table games, such as a first main table game and a second separate and disparate main table game. Each gaming table preferably includes a surface adapted for the play of such main table games and a gaming table tracking device adapted to facilitate the tracking of gaming events associated with players or patrons playing wager based games at the gaming tables. The disclosed systems and methods can also include the provision of a system controller, such as a progressive table game bonus server in communication with the various gaming tables and/or gaming table tracking devices. Such a progressive table game bonus server can be adapted to track specific gaming activities at the various gaming tables, provide eligibility to a singular progressive table game bonus to patrons based on the play of games at the various gaming tables, and determine a progressive table game bonus outcome based on the specifically tracked gaming activities and provided player eligibilities.

In various embodiments, the progressive table game bonus server can be further adapted to provide eligibility to a progressive table game bonus to patrons based solely on main wagers made by patrons with respect to wagers made on and/or the play of main table games. The progressive table game bonus server can also be adapted to determine all table game patrons eligible for a given progressive table game bonus, to track wagering information with respect to each said eligible table game patron, to award an appropriate number of entries to the given progressive table game bonus to each eligible table game patron based on such wagering information, and to grant a progressive table game bonus award based at least in part on the appropriate number of bonus entries assigned to each eligible table game patron. In some embodiments, such a progressive table game bonus can be a singular bonus, and in some embodiments, such a bonus can be part of a series of bonuses.

The awarding of “entries” to a progressive table game bonus can be based on expectation values associated with main table game wagers made by patrons. A portion of main table game wagers can be used to fund the progressive table game bonus, with such portions preferably corresponding to the expectation values of those main table game wagers and/or the number of progressive bonus entries awarded for those main table game wagers. In some embodiments, funding for the various progressive table game bonuses can come primarily or entirely from portions of main table game wagers. The number of bonus entries awarded for a main game wager of a particular monetary amount can vary based upon the varying expectation value of such a wager. In this manner, the number of entries awarded for main game wagers of like amounts will be different where the wagers are made on different things or in disparate types of table games. Although it is possible to base the number of bonus entries awarded to a patron on the actual identity of a patron, particularly for the most preferred patrons, such bonus entries will often not be based on patron identity. Progressive table game bonus entries can be awarded on a normalized basis, such as where a determination is made with respect to the lowest expectation value possible with respect to an eligible gaming table wager on an eligible gaming table.

In various embodiments, a given progressive table game bonus can comprise a jackpot pool. Bonus awards can then be made from such a jackpot pool, and bonus funding can be made to the jackpot pool, such as from portions of main table game wagers. Similar to the foregoing, portions of main game wagers used to fund the jackpot pool may correspond to respective expectation values of the main table game wagers. The jackpot pool could fluctuate in size based upon contributions and bonus awards paid out, and the size of at least one bonus award made from a progressive table game bonus can be based on the size of this jackpot pool at the time that the bonus award is made. The progressive table game bonus server or system can be further adapted to award entries to a singular progressive table game bonus based upon main game wagers, and such awards of bonus entries can correspond to the respective expectation values of the main game wagers and the portions thereof one used to fund the jackpot pool.

In some embodiments, the progressive table game bonus server or system can be adapted to determine one or more progressive table game bonus outcomes randomly and without respect to the outcome of any main table game, while in other embodiments, one or more triggering mechanisms can be used to aid in starting the bonus process and/or determining the progressive bonus outcome. Such triggering mechanisms can include a specific date, time, aggregate amount wagered, aggregate expectation value reached, game outcome(s), and the like. The progressive table game bonus server or system can be further adapted to determine a winning outcome for a progressive table game bonus outcome, with such a winning outcome resulting in a bonus monetary grant to at least one patron. In various embodiments, such a winning outcome can result in simultaneous bonus monetary grants to a plurality of patrons, resulting in a more festive and collegial gaming atmosphere.

In various embodiments, the various types of main table games can include poker, blackjack, baccarat, craps, roulette, pai-gow, Carribean Stud, Spanish 21, and Let It Ride, among others. Although it is possible for any combination of different types of main table games to be included in the progressive table game bonus systems and method provided herein, it is preferably that at least two disparate types of main table games be involved. In some embodiments, many or all of the foregoing types of main table games can be involved in the same progressive table game bonus.

In various embodiments, the progressive table game bonus server or system can be further adapted to provide eligibility to one or more progressive table game bonuses only to patrons playing with player tracking identifiers, such as player tracking cards assigned to respective patrons. Such embodiments can be in addition to one or more of the foregoing and following embodiments. It will be understood that the various embodiments provided herein can be included or excluded as may be desired to result in a wide variety of possible combinations. For example, some embodiments can include the actual gaming tables, while others may include only the progressive table game bonus server or system controller. Such limited embodiments might involve only communication links to gaming tables and/or tracking devices.

In still further embodiments, various methods of providing a progressive table game bonus are set forth. Such methods can include providing a plurality of gaming tables adapted for hosting wager based gaming events, as well as tracking devices, and also a progressive table game bonus server or controller. Further method steps can also include accepting a first main table game wager from a first patron at a first gaming table, administering a first main table game at the first gaming table, contributing a portion of the first main table game wager to a progressive table game bonus jackpot pool, accepting a second main table game wager from a second patron at a second separate gaming table, administering a second main table game at the second gaming table, contributing a portion of the second main table game wager to the same progressive table game bonus jackpot pool, providing eligibility to win the same progressive table game bonus to both of the first and second patrons, and determining a progressive table game bonus outcome. Of course, it is contemplated that the second main table game be a disparate type of game from the first main table game, and also that the level of eligibility for each player be based on their respective main table game wagers. Such eligibility may be based solely on the main table game wagers, and can be provided by way of entries to the progressive bonus. Eligibility for additional players may also be provided, and the first and second gaming tables may be within the same pit, same casino, or at different casinos either locally or across a country or the world.

Further method steps can include determining a normalization process for the awarding of entries to the progressive table game bonus, awarding a first number of bonus entries to the first patron based on the first main table game wager and this normalization process, awarding a second number of entries to the progressive table game bonus to the second patron based on the second main table game wager and the normalization process, and granting a progressive table game bonus award based at least in part on the bonus entries awarded to each eligible table game patron.

In still further embodiments, the initial determination of a progressive table game bonus outcome can be with respect to a first level bonus, with further bonus levels also being available. Further steps can then include determining additional progressive table game bonus outcomes, with such additional progressive table bonus outcomes being based upon additional level bonuses, wherein such additional level bonuses are based upon a subset of gaming tables from the other bonus levels. Such additional level bonuses can include a second level bonus, where the gaming tables used for such a second level bonus are only a subset of the gaming tables used for the first level bonus, a third level bonus, where the gaming tables used for the third level bonus are only a subset of the gaming tables used for the second level bonus, and so forth.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and process steps for the disclosed inventive progressive bonusing systems and methods for table games. These drawings in no way limit any changes in form and detail that may be made to the invention by one skilled in the art without departing from the spirit and scope of the invention.

FIG. 1 illustrates in perspective view an exemplary specialized gaming table according to one embodiment of the present invention.

FIG. 2 illustrates a block diagram of a network infrastructure for providing a progressive table game bonusing system distributed across a gaming establishment according to one embodiment of the present invention.

FIG. 3 illustrates a block diagram of an exemplary progressive table game bonusing database and associated files therein according to one embodiment of the present invention.

FIG. 4 illustrates a flowchart of one exemplary method of providing a series of tiered progressive table game bonuses according to one embodiment of the present invention.

FIG. 5 illustrates a flowchart of one exemplary method of generally providing a progressive table game bonusing across multiple gaming tables having disparate main table games according to one embodiment of the present invention.

### DETAILED DESCRIPTION

Exemplary applications of systems and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

One advantage of the present invention is the introduction of systems and methods that provide a singular and/or series of progressive table game bonus(es) across a plurality of gaming tables. This can be accomplished at least in part by the introduction of a comprehensive tracking system, which is able to track wagers at any participating venue within the casino environment. In some embodiments, a separate dedicated progressive table game bonus server is used to track various disparate gaming activities, and in some instances to aid in the award of bonuses where appropriate. This is particularly useful where a casino or other gaming establishment desires to provide a more comprehensive bonusing and/or themed system to appeal to all players of all games within the casino.

### Gaming Tables and Systems

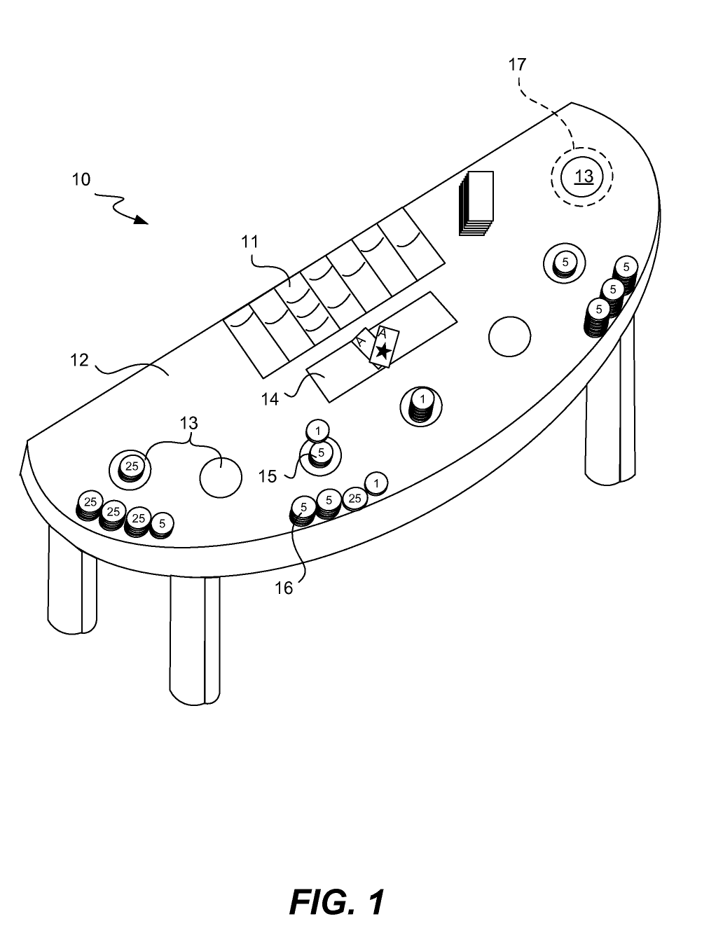

Referring to FIG. 1, an exemplary specialized gaming table according to one embodiment of the present invention is illustrated in top perspective view. From its outer appearance, specialized gaming table 10 preferably looks to be just like any other gaming table adapted to play a similar main table game that a patron might encounter at a casino or other gaming establishment. Differences between specialized gaming table 10 and any other ordinary gaming table can include the presence of any of a number of suitable devices and items adapted for the automated tracking of wagers and other gaming activities. While such wager and other gaming activity tracking can potentially be done manually, it is specifically contemplated that such tracking be at least partially automated.

For example, RFID based gaming chips can be in use at the table, as well as RFID reading devices and other related components, which may preferably be located beneath the gaming table or in other non-obtrusive locations. The use of such RFID gaming chips and reading devices is known, and various details regarding the use of RFID tags within gaming chips to facilitate gaming chip identification and tracking can be found at, for example, U.S. Pat. Nos. 5,651,548 and 5,735,742, as well as copending and commonly owned U.S. patent application Ser. No. 11/224,903, filed on Sep. 12, 2005, and entitled “Enhanced Gaming Chips and Table Game Security,” each of which is incorporated by reference herein in its entirety and for all purposes. Alternatively, gaming chip tracking at gaming tables can be accomplished by way of cameras or other visual equipment, as well as various image processing and software tracking programs. Further details of such visually based gaming chip tracking applications can generally be found at, for example, U.S. Pat. Nos. 5,781,647; 6,313,871; 6,532,297; and 6,663,490, each of which is also incorporated by reference herein in its entirety and for all purposes.

Specialized gaming table 10 has been adapted for use with RFID based gaming chips and reading devices, although it will be readily understood that any other suitable wager and gaming activity tracking system may also be used. As such, gaming table 10 has a chip tray 11 adapted to store a plurality of gaming chips, including RFID gaming chips, as well as a gaming surface such as upper surface 12 adapted for the play of games and various other gaming transactions involving gaming chips, cards, markers and the like. Various chip placement areas 13, 14 are distributed about the upper surface 12 of the gaming table 10. Such chip placement areas can include bet or wager placement areas 13, as well as a cash for chips or other marker conversion area 14. Gaming chips 15, 16 of one or more denominations may also be located atop the upper surface 12 of the gaming table, particularly during times of gaming activity at the table. For example, gaming chip 15 is a $5 chip that is subject to a current wager in a bet placement area, while gaming chip 16 is a $5 chip that is not subject to a current play or action at the gaming table.

As will be readily appreciated, gaming chips 15 and 16 may be identical or substantially similar, with the possible exception of RFID tags contained within or about the chips. Such RFID tags might be located at the gaming chips in various configurations, as detailed in previously noted U.S. Pat. Nos. 5,651,548 and 5,735,742, and U.S. patent application Ser. No. 11/224,903. In order to facilitate the automated or semi-automated tracking of gaming chips, and by extension wagers and other gaming activities at specialized gaming table 10, one or more RFID readers 17 can be placed at various locations about the gaming table. While only one RFID reader 17 has been illustrated under a single bet position 13, it will be readily appreciated that a number of RFID readers may be similarly situated about the gaming table, as may be suitable for the accurate reading of chips and wagers.

Although specialized gaming table 10 has the general appearance of a blackjack table or a gaming table for a similarly distributed and played main table game, it will be readily appreciated that the gaming tables used in conjunction with the present invention can also be extended to other forms of gaming tables and even alternative gaming venues. For example, similar specialized gaming tables or alternative venues can be adapted for use as a craps table, a roulette layout, and/or a sports book counter or presentation, among other suitable gaming tables or venues. In fact, it is specifically contemplated that any gaming table, counter or venue where a wager can be tracked with respect to a particular player can be involved in the progressive table game bonusing systems and methods provided herein. Thus, where keno wagers, sports book wagers, and other gaming transactions of any sort can be correlated and tracked to a player, such game plays or transactions can also be included as part of the progressive table game bonus system. For such transactions to be tracked, in some instances it may become necessary for a given player to provide a positive player identification, which may be accomplished through the use of a casino assigned player-tracking card, for example.

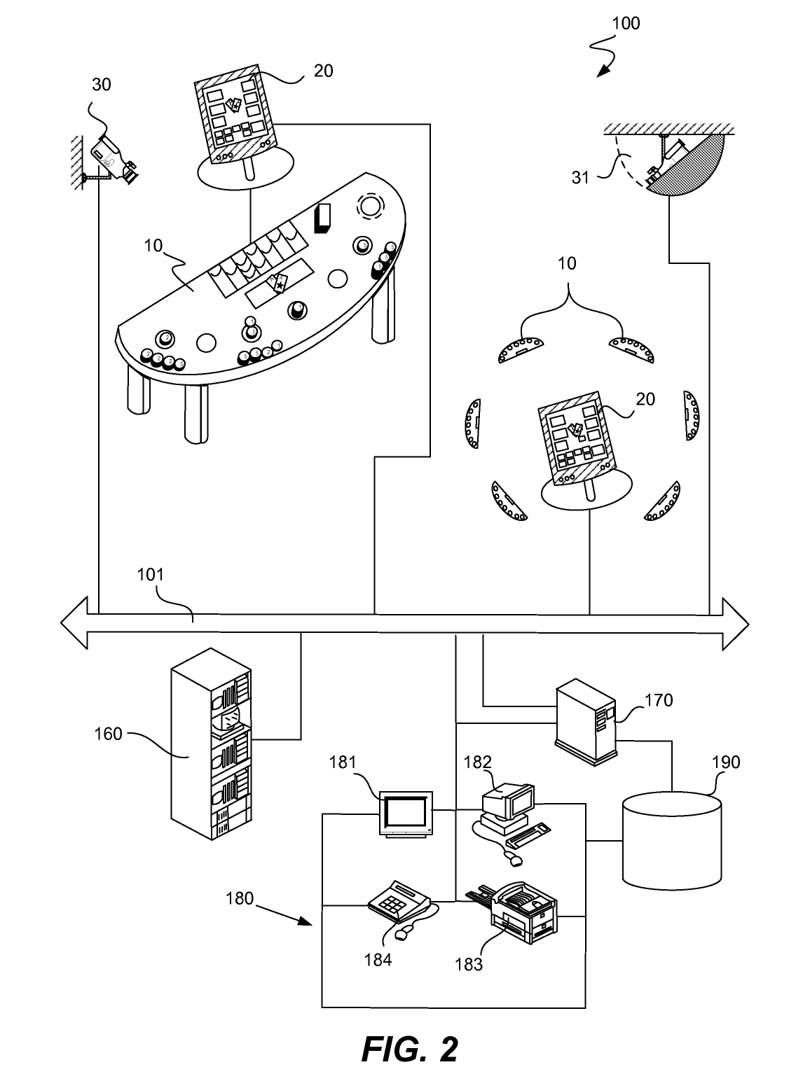

Turning next to FIG. 2, an exemplary network infrastructure for providing a progressive table game bonusing system distributed across a gaming establishment is illustrated in block diagram format. Progressive table game bonusing system 100 interconnects a plurality of specialized gaming tables 10, preferably by way of one or more table tracking devices, such as pit tracking device 20, with a number of host-side components and devices adapted for use within a gaming environment. Each pit tracking device 20 can be adapted for use with a plurality of gaming tables, such as, for example, six gaming tables grouped within a given pit area. As shown, a plurality of specialized gaming tables 10 adapted for use in progressive table game bonusing system 100 can be in a plurality of locations, such as in groups in a pit on a casino floor or standing alone at an isolated location, as desired. Although only a limited number of gaming tables are shown for purposes of illustration, it will be understood that many or all of the gaming tables in a given pit area or on a casino floor can be interconnected to and a part of the progressive table game bonusing system 100. In addition, various other gaming venues or locations where gaming related transactions may occur (not shown) can also interconnected to and part of the progressive table game bonusing system 100. Again, such venues can include keno lounges, sports books, cashiers cages and any other location where gaming wagers and related transactions can be tracked and correlated to players.

Various additional automated or semi-automated components on or about the casino floor may also be part of the progressive table game bonusing system 100. For example, surveillance devices such as wall camera 30 and ceiling camera 31 may be utilized for a variety of related functions. Such functions can include bet tracking and tracking of other gaming activities, as noted above, as well as security and player identification functions. Such cameras, other surveillance devices and/or other components can all be connected to a host side of the system via any of a number of suitable connections, such as by a common bus 101. Connections can be hard wired, as shown, or can also be via any suitable wireless means, as may be desired.

Host side components can include, for example, a general-purpose server 160, one or more special-purpose servers 170, at least one sub-network of peripheral devices 180, and/or a database 190. A general-purpose server 170 may be one that is already present within a casino or other relevant gaming establishment for one or more other purposes beyond any functions associated with a progressive table game bonusing system. Functions for such a general-purpose server can include, for example, other general and game specific accounting functions, payroll functions, general Internet and e-mail capabilities, switchboard communications, and reservations and other hotel and restaurant operations, as well as other assorted general establishment record keeping and operations. In some cases, specific gaming related functions such as cashless gaming, downloadable gaming, player tracking, remote game administration, video or other data transmission, or other types of functions may also be associated with or performed by such a general-purpose server. Such a server may contain various programs related to player tracking operations, specific player account administration, remote game play administration, remote game player verification, downloadable gaming, and/or visual image or video data storage, transfer and distribution, and may also be linked to one or more gaming machines, in some cases forming a network that includes all or many of the gaming machines, devices, gaming tables, and/or other gaming related venues within the gaming establishment. Communications can then be exchanged from each adapted gaming machine, gaming table and gaming venue to one or more related programs or modules on the general-purpose server.

In some embodiments, progressive table game bonusing system 100 contains one or more special-purpose servers 170 that can be used for various functions relating to the provision of various specialty functions within a casino, such as progressive table game bonus tracking, administration and operation under the present methods and systems. Such a special-purpose server or servers could include, for example, a cashless gaming server, a player verification server, a general game server, a downloadable games server, a specialized accounting server, and/or a visual image or video distribution server, as well as a server dedicated solely to tracking and administering universal bonuses, among others. Of course, these functions may all be combined onto a single server, such as illustrated specialized server 170. Such additional special-purpose servers are desirable for a variety of reasons, such as, for example, to lessen the burden on an existing general-purpose server or to isolate or wall off some or all gaming machine administration and operations data and functions from the general-purpose server, and thereby increase security and limit the possible modes of access to such operations and information.

Alternatively, exemplary universal bonus system 100 can be isolated from any other network at the establishment, such that a general-purpose server 160 is essentially impractical and unnecessary. In such an isolated embodiment, it may be preferable to have only a specific purpose server 170 dedicated solely to tracking and administering progressive table game bonuses and related functions. Alternatively, in lieu of total isolation from all other casino networks, such a part progressive table game bonusing system might be tied into an existing player tracking network. Under either embodiment of an isolated or shared network, one or more of the special-purpose servers are preferably connected to sub-network 180, which might be, for example, a cashier station or terminal, or a management back room where gaming operations can be monitored remotely. Peripheral devices in this sub-network may include, for example, one or more video displays 181, one or more user terminals 182, one or more printers 183, and one or more other input devices 184, such as a card reader or other security identifier, among others. Under either embodiment of an isolated or shared network, at least the specialized server 170 or another similar component within a general-purpose server 160 preferably includes a connection to a database or other suitable storage medium 190. Database 190 can be adapted to store many or all files containing pertinent data or information regarding progressive table game bonuses, among other potential items. Files, data and other information on database 190 can be stored for backup purposes, and are preferably accessible at one or more system locations, such as at a general-purpose server 160, a special purpose server 170 and/or a cashier station or other sub-network location 180, as desired.

While progressive table game bonusing system 100 can be a system that is specially designed and created new for use in a casino or other gaming establishment, it is also possible that many items in this system can be taken or adopted from an existing gaming system. For example, progressive table game bonusing system 100 could be “piggybacked” onto an existing player tracking system, to which one or more progressive table game bonusing components or program modules are added. In addition to new hardware, new functionality via new software, modules, updates or otherwise can be provided to an existing database 190, specialized server 170 and/or general-purpose server 160, as desired. In this manner, the methods and systems of the present invention may be practiced at reduced costs by gaming operators that already have existing gaming systems, such as an existing player tracking system, by simply modifying the existing system. Other modifications to an existing system may also be necessary, as might be readily appreciated, in order to implement the various progressive table game bonus systems and methods provided herein.

According to various embodiments of the present invention, it is generally preferable that players eligible to win a singular progressive table game bonus or any of a series of progressive table game bonuses are generally those players playing at games where specific player activities are tracked. For example, it is generally well known in the art that player tracking systems are frequently associated with gaming machines. In such systems, players can insert their player tracking cards into a gaming machine while the player plays the gaming machine, and player tracking points or credits are granted to the player based on the length and levels of play. In a similar manner, player tracking cards may also be used at gaming tables, such as where players hand their cards to a dealer or other casino personnel to track player activities at the gaming table. Accordingly, use of an existing player tracking system adapted for use with table games, particularly to communicate with a specialized progressive table game bonusing server, may a preferable approach to implementing such a progressive table game bonusing system. Similar player tracking approaches can be used to permit players of other game offerings at the casino to participate in the progressive table game bonusing programs, such as, for example, at keno lounges and sports books. In such instances, a player could similarly provide his or her player-tracking card to be eligible for the progressive table game bonus.

### Comprehensive Progressive Table Game Bonusing

In general, the various progressive table game bonusing systems and methods provided herein enable players that play at gaming tables to take advantage of a common progressive bonus or series of bonuses available to all gaming table players. Players can then be motivated to continue to play the table games that they enjoy, while feeling as though they are a part of an overall or comprehensive progressive table game bonus system or casino theme. For example, a husband may enjoy craps games, while his wife may enjoy blackjack. Under the present system, both the husband and wife can take part in the same progressive table game bonusing program. In addition, players could also be motivated to try new types of table games, since there would at least be some familiarity of the player and comfort associated with the common progressive table game bonusing aspect of a new table game that a player might try. The singular or series of progressive table game bonuses could then be directed to any patron making a wager on a main table game at a respective gaming table. Such a bonus might be called a “progressive all table game bonus,” a “lucky wager bonus,” a “total rewards bonus” or the like.

Depending upon the exact genre or type of a table game, the generally expected take or “expectation value” to the casino for that table game type, and/or various other factors relating to size of wager, player profile, and so forth, a wide variety of factors could be used for determining player eligibility and chances to win for a given common progressive table game bonus or series of bonuses. For example, in many embodiments a progressive table game bonus might be funded by taking a small portion of all wagers from all table games that are eligible to participate in the bonus. For table games such as blackjack and craps, where the house edge is traditionally lower than other games, a smaller portion of each wager might be taken to provide for a progressive table game bonus jackpot pool, while other games having a higher house edge, such as, for example, American roulette, might be used to provide a relatively larger contribution to such a bonus jackpot pool.

As a particular specific example, it is generally known that a wager on the “pass line” at craps is one of the more favorable player wagers at all table games within a casino or gaming establishment, as the “house edge” on a simple pass line bet is about 1.41%. That is, a casino or other gaming establishment (i.e., “house”) can expect to take on average and in the long run about $1.41 for every $100 player wager on the pass line at a craps table game. As such, the expectation value (“Ev”) for the house on any given $100 pass line wager is about $1.41, with such an Ev thus correlating to $0.0141 for every dollar wagered on the pass line. If the minimum wager at a craps table in a particular casino is $10, then the house Ev for such a minimum $10 wager on the relatively player favorable pass line is about 14.1 cents. While many gaming establishments would likely wish to retain all or most of this Ev as house profits for each wager made therein, it is certainly reasonable to consider that a small portion of each Ev could be used to fund a table game bonus jackpot pool, such as the progressive table game bonus pool and other jackpot pools disclosed herein. For example, ten percent of the house take or “Ev” for every table game wager might be used to fund a table game bonus jackpot pool. In this particular example then, 1.41 cents of every 14.1 cents from the house Ev for a minimum $10 pass line wager could be used to fund a table game bonus jackpot pool. Of course, such a contribution might be rounded off, such as to one cent rather than 1.41 cents, as may be desired. With the assistance of the various servers and other computing devices that can be used with the present system, however, it is thought that detailed fractions of cents might be used in computing contributions to a jackpot pool.

Larger pass line wagers could be used to fund the jackpot pool in a correlating fashion. For example, every dollar wagered on a pass line could result in a 0.141-cent contribution to a table game bonus jackpot pool, such that a $100 pass line wager could result in about a fourteen-cent contribution to a table game bonus jackpot pool. Bonus pool contributions from other table games might be calculated differently based on the house odds for such games, and it is contemplated that the contribution from each type of table game and each type of table game wager correlate at least roughly to the house odds or Ev for that particular table game or table game wager. As another example, if the house edge on a particular American roulette wager is about 5.31% (i.e., the house Ev is about $0.0531 for every dollar wagered), then a respective correlating contribution to a progressive table game bonus jackpot pool for every dollar placed as a standard roulette wager could be 0.531 cents. Thus, while a $100 pass line wager might result in a 14.1 cent contribution to a table game bonus jackpot pool, a similar $100 roulette wager might result in a 53.1 cent contribution to that same table game bonus jackpot pool. Further calculations of similar pool contributions can be made based on the size and Ev of any particular table game wager, as will be readily appreciated by those skilled in the art.

Depending upon the amount of contributions from each type of game, different odds might also attach to the requirements that need to be met for a bonus win or award at a particular type of gaming table. For example, a game that may not contribute as much money in proportion to the amounts being wagered to the overall jackpot pool or bonus prize fund may result in lowered odds for a participating player or patron to hit one or more of the progressive bonuses being offered. Such table games might include, for example, craps and blackjack, where the take or expectation value of each wager to the gaming establishment is relatively low. In contrast, table games that are more favorable to the house, such as even money blackjack and roulette, might contribute more funds to the overall jackpot pool in proportion to the amounts wagered, and thus could also have more favorable odds of winning a common bonus to players of such games. Various ways of providing players with differing chances to win a given bonus jackpot based on their relative contributions are set forth in greater detail below.

In some embodiments, the progressive table game jackpot pool might also be funded by side bets and/or other contributions, such as a contribution from a side promotional fund by a given gaming establishment. Although such alternative forms of funding are possible, it is preferable that the funding for such a progressive table game bonus be primarily or entirely from ordinary wagers made on ordinary main table games. Of course, such funding could also involve a combination of regular table game contributions and side funding by a casino or other gaming establishment, such as from a promotional fund. Further funding sources might also include providing players with the ability to gain extra bonus chances or “entries” by letting players make extra bonus related side wagers or contributions, such as alongside a main table game wager. By providing such additional universal progressive table game bonuses across a table, pit, casino, enterprise, WAN, and the like, it is contemplated that a gaming establishment or coalition of gaming establishments can create additional excitement and player loyalty amongst players, particularly those players who are inclined to play table games.

As part of such a universal progressive table game bonus, it is preferable that every main table game bet is eligible for the bonus. In order to make such a comprehensive table game bonus work, the chance of winning for any given ordinary table game wager is preferably proportional to the wager amount and its respective expectation value to the host casino or other gaming establishment. In many embodiments, the highest bonus or jackpot award preferably occurs less frequently, and when such a large bonus or jackpot occurs, every eligible player at the table or in the pit, casino or other relevant area wins and can take part in the bonus award. A primary winning player can take a significant portion of the bonus award, such as, for example, 50% or 80%, with the remainder or residual amount to be split amongst all remaining eligible players who had wagers in play when the bonus was hit. Lesser or lower level awards can be more localized, such as to a single gaming table and are preferably paid out more frequently. Of course, the more money that is wagered, the greater the odds that someone at a given table, pit or casino floor will win one of the available progressive bonuses or jackpots at some level.

One way of providing eligibility for a table game bonus is to award bonus “entries” for a respective bonus or set of bonuses for any eligible wager or other suitable action made by a player at a gaming table. As noted above, such bonus eligibility or entries may be based on the Ev of a given wager, which Ev can be determined as a function of the size of a wager and the type of game or wager and relevant odds involved. Referring back the foregoing examples, a relatively low Ev type of wager might be a minimum $10 on the pass line at a craps table. In such an instance, a player making this wager might be provided or granted one entry to the overall progressive table game bonus based on such a wager. Conversely, a player making a similar $10 wager on a standard roulette bet might be awarded 4 or 5 entries to the same overall progressive table game bonus. Where such a wager is larger, then the number of bonus entries may grow in proportion. Thus, a $100 wager on the pass line might result in 10 bonus entries. Of course, there may be some instances where a casino or other gaming operator may not wish to provide or grant any bonus entries, such as for an “odds” type wager atop a pass line bet at craps (where the Ev is 0).

In many embodiments, there can be an exact or at least strong correlation between the bonus pool contribution of a particular wager and the number of bonus entries awarded to the player making such a wager. For example, every $0.01 that is contributed to the bonus pool can result in one bonus entry for the player responsible for such a contribution. As seen from the foregoing examples, this could result in one entry for a $10 pass line wager and five entries for a $10 standard roulette wager. In further embodiments, additional entries might be awarded to players based upon high levels of play. Such high levels of play can be determined with respect to particularly large wagers, sustained play over a period of time, or some combination thereof. For example, where a high roller might make consistent $1000 wagers at a table game, the overall table game bonus system might be structured to reward such a player with additional bonus entries beyond those which are normally provided or awarded, particularly due to the increased Ev that such a high roller is providing to the gaming establishment through his or her play. Such additional bonus entries can be Ev based, wager level based, and/or temporally based. For example, any player who provides a large Ev to the casino based only on his or her own wagers might be provided with one extra bonus entry for every Ev multiple of $100 over a given 30 minute period.

In some embodiments, a normalization process can be utilized for the providing or awarding of bonus entries. Such a normalization process can involve determining the lowest Ev for the lowest possible wager at any gaming table that would be eligible to participate in the progressive table game bonus. Keeping with the foregoing examples, such a lowest Ev might be for a $10 wager on the pass line at a participating craps table. Such a lowest Ev minimum wager might be assigned, for example, one entry to a given progressive table game bonus. All other entry awards for all other participating gaming tables and wagers can then be based upon this normalization process, where any other wager that is of higher Ev and/or greater monetary amount would receive a multiple number of bonus entries, with such a number correlating to the greater value of that wager with respect to the minimum expectation value and minimum monetary amount wager.

In some embodiments, the base or normalized low number of bonus entries for the lowest or “normalized” Ev wager might be more than one, such as where an incrementally higher value wager of a different type or at a different game might not be worth double or any multiple number of entries with respect to the base number. For example, where the base or normalized lowest Ev wager is only slightly lower than the next lowest Ev wager at an eligible table game, the base or lowest wager might be awarded three bonus entries, while the next lowest wager might be awarded four entries. Such an outcome might result from comparing a pass line wager at craps to a smaller minimum wager at blackjack, for example. All other wagers of higher expectation values and/or higher monetary amounts would then be granted a greater number of bonus entries as may be warranted. Of course, any provision where more entries are awarded based on such a normalization would then result in a need to adjust the odds calculations for any particular entry being able to win a particular progressive table game bonus. Alternatively to the foregoing, a base or normalized value of “one” can be established, and all bonus entries to be awarded can be rounded down to the next lowest integral value, such that a wager having a slightly higher but similarly low Ev with respect to a $10 pass line wager would also get just one bonus entry.

In some embodiments, there can be a fixed probability for all entries to a given progressive table game bonus, while in other embodiments, the odds of winning can change based on number of entries, such that a given type of bonus win within any given time frame is always equally likely. Of course, the win amount can be adjusted given the number of times any given bonus is won. Because many of the provided table game bonuses are progressives, the overall win amount will preferably continue to rise until a bonus award is won. In many embodiments, it is preferable that a bonus outcome determination be completely random, such as that which can be determined by a pure random number generator (“RNG”), as is generally known in the art. For example, where the odds of hitting a large WAP progressive table game bonus are 100,000,000 to one, then a player earning, for example, 10 entries to that bonus level for a given wager would be awarded 10 separate chances to hit a 100 million to one shot. Similar procedures can be applied to different entry amounts for different bonus prizes having different odds, as will be appreciated.

With respect to determining such a progressive table game bonus outcome based on the number of entries for a player (i.e., the number of entries being derived from player eligibility, which is turn derived from specific gaming activities), an RNG can be used in a variety of ways to determine whether any given entry or group of entries is or contains a winning bonus outcome, as will be readily appreciated. As one particular example, where the odds of hitting or winning a given table game bonus are 100,000,000 to one, a particular predetermined “winning number” or value from 1 to 100,000,000 can be established, such as by RNG, manual designation, or otherwise. The RNG can then be utilized to determine an “entry number” at random from 1 to 100,000,000 for a given entry. If this RNG determined “entry number” matches the “winning number,” then that entry is deemed a winner for that table game bonus. In some embodiments, outcomes for multiple bonus entries can all be determined one by one (i.e., in series) versus such a winning number, while in other embodiments, a group of entries granted at the same time can all be determined in bulk, or at once (i.e., in parallel). In some parallel bonus outcome determinations, each different bonus entry might be assigned a different “entry number,” whereupon comparison can be made against a “winning number” or numbers simultaneously, and in other such outcome determinations, each different bonus entry might be assigned an entry number purely at random, with duplication being made possible. Of course, other odds and numerical ranges may also be used for any particular prize, such as, for example, 1 billion or 5 billion to one.

In many embodiments, as set forth in greater detail below, a tiered set of bonuses may be available to any given bonus entry or group of bonus entries, whereby a group or series of winning numbers for different levels of bonuses can be involved. In such instances, bonus outcomes can be determined for all tiered bonuses at once (in parallel), or bonus outcomes can be determined for each level of the tiered bonuses separately (in series). Of course, the odds for different levels of a tiered bonus might be different, such that the ranges for a possible “winning number” and entry numbers for any given bonus level can vary. For example, for a smaller table or pit level table bonus, the odds of winning might be 100,000 to 1, such that one winning number and all entry numbers can be randomly determined from this numerical range. Alternatively, where all levels of bonuses are to be determined at once, a plurality of “winning numbers” for a smaller level bonus prize might be established within the larger numerical range for the bigger level bonus prize.

In the foregoing examples where one number is selected between 1 and 100,000,000 for a large WAP bonus level, and a bonus outcome is to be determined for this large bonus level and the smaller 100,000 to 1 pit or table bonus level at the same time, then 1000 “winning numbers” for the smaller bonus can be established or set within the larger 1 to 100,000,000 numerical range needed for the large bonus outcome determination. In this manner, a single RNG determined entry number for a single bonus entry can be compared against the lone winning number for the bigger level bonus prize and the 1000 winning numbers for the smaller level bonus prize to make a bonus outcome determination for both bonus levels simultaneously. It will be readily appreciated that this example may be suitably extrapolated to include even further bonus levels having differing odds of winning.

In such instances where progressive or other forms of table game bonus outcomes are determined in purely random fashion, or otherwise as may be suitable, it is preferable that the entire system of participating gaming tables be able to operate within the collective shared table game bonuses and function as regular gaming tables asynchronously. That is, no gaming table need wait for an outcome or action at any other gaming table to be able to function normally while still participating in an overall table game bonus or series of tiered table game bonuses. As such, any table game bonus can be hit or won at any participating gaming table at any time. Contributions to the bonus jackpot pool or pools, and outcome determinations for each wager or other pertinent eligible gaming activity at any participating gaming table are all made in real-time, with calculations for both contributions to the pool and bonus outcome determinations being made by the progressive table game bonus server or other relevant system computing device on demand and as events occur.

Alternatively, rather than have a purely random bonus determination, a particular predefined trigger or triggers may be used as part of the bonus outcome determination. Such a trigger or triggers may be part of a mystery bonusing that is not known to the players, or may be widely publicized. Such a bonusing trigger may involve, for example, the occurrence of multiple blackjacks in a short time frame in a given area, or some other condition as defined by the casino. In some embodiments, the trigger condition can result in a randomly generated lottery system that picks a definite winner for the bonus. In another particular example, the progressive table game bonus system can be adapted to track exact rolls at a plurality of different craps tables. When a particular sequence of rolls are observed across all participating tables, such as, for example, four consecutive rolls of “eleven,” then this triggers a progressive jackpot. The jackpot, or a substantial portion thereof, could then be paid to the player who rolled the last “eleven” in the sequence of triggering craps rolls. Alternatively, the jackpot, or a substantial portion thereof, could be split between the four players who made the triggering sequence of rolls of “eleven.” Further examples of bonus triggering events can be found in commonly owned and co-pending U.S. patent application Ser. Nos. 11/122,344 and 11/225,299, entitled “Ticket Drawing Games Having Escalating Discrete Prize Levels” and “Universal Casino Bonusing Systems and Methods” respectively, both of which are incorporated herein by reference and for all purposes. Of course, many other triggering events and sequences may be used, and it is specifically contemplated that any such suitable triggering event or sequence can be used in conjunction with the present invention.

In some embodiments, a specialized lighted table bolster can be used to indicate a progressive bonus win. Such a table bolster can be adapted to light up all around one or more participating gaming tables, with the most vibrant lights being indicated in front of the main or primary winner(s) of the bonus. The specialized table bolster can also be used to indicate which players are participating in the game and/or progressive bonus, which can be particularly useful where residual progressive bonus amounts are to be paid to a number of players, some of which will be eligible for a residual bonus amount, and some of which may not be. For example, if a player is sitting at an eligible gaming table, but was not actually playing in the main table games at that table when a progressive bonus is hit, then that player might not be eligible for any residual progressive bonus portion.

Because bonus contributions and bonus outcome determinations are all preferably being made in real-time by a system server or other rapid computing device, and because many bonus entries are determined solely upon wagers made, many bonus jackpot wins can be awarded even before the play of a table game is finished. For example, a bonus jackpot might be indicated at a craps table before the thrown dice even land, based on all table wagers being locked in the moment a player throws the dice and the bonus system being able to detect all wagers, compute bonus outcomes and relay a winning outcome to the winning gaming table or tables, which can then indicate a win all within seconds or even a fraction of a second. Similarly, a winning bonus outcome can be indicated at a blackjack table or group of blackjack tables just as soon as all wagers are locked in and the dealer begins to deal hands at the table. Such immediate notification of a progressive bonus win at any level may add to the overall excitement and enjoyment of the gaming experience for players.

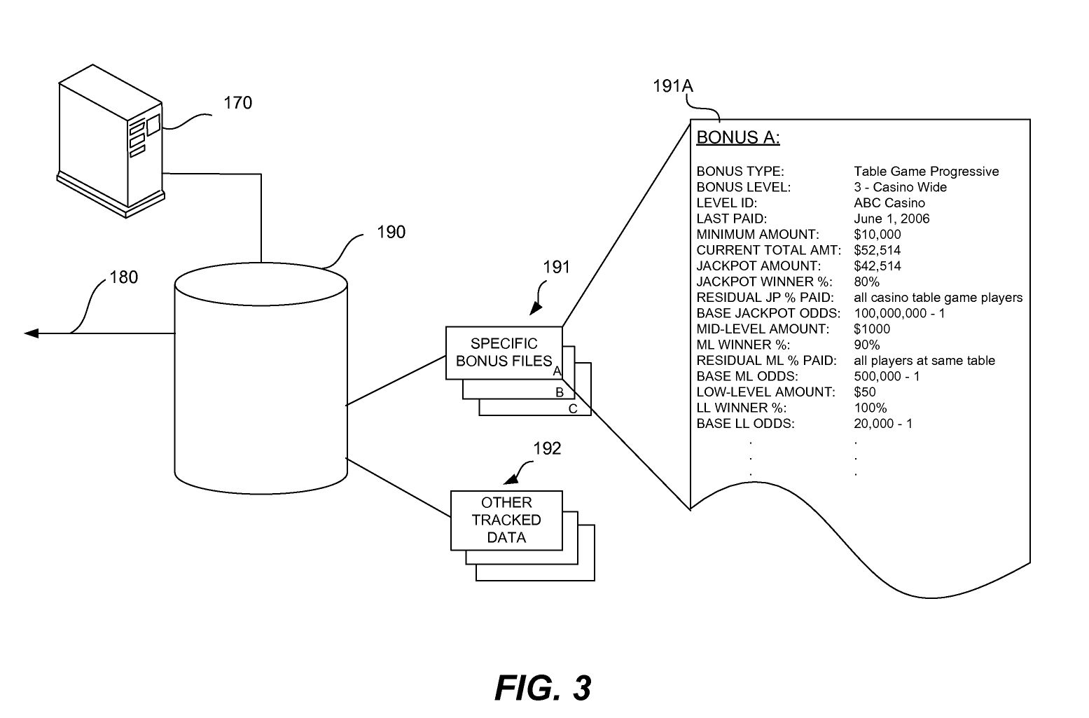

Referring to FIG. 3, a block diagram of an exemplary progressive table game bonusing database and associated files therein are illustrated according to one embodiment of the present invention. As similarly illustrated in FIG. 2, database 190 is preferably accessible to one or more servers, such as progressive table game bonus server 170, and has a connection to a network 180 of one or more peripheral devices. Database 190 preferably contains information related to a plurality of progressive table game bonuses such as specific bonus files 191, and can also include other tracked data and informational files 192, such as, for example, player tracking information, bonus accounting information, and the like.

Specific bonus files 191 can be classified in a variety of possible ways, as may be desired. In the illustrated example, bonus file 191A is classified with respect to the progressive bonus type and particular bonus level. Contained within each file can be numerous informational items, restriction requirements, if any, security issues, and other potential data. In the exemplary bonus file 191A illustrated, pertinent bonus file information can include items such as, for example, progressive bonus type, progressive bonus level, and an identifier for the particular bonus level, such as a given casino (as in this instance), pit area, table or the like. Additional file data can include the date that a jackpot bonus from the level was last paid, a minimum amount for the jackpot bonus of the bonus level, a current total amount for the bonus level, a current jackpot amount for the bonus level, and other bonus amounts for smaller bonuses available within the bonus level. Still further information can include the percentages of a bonus win that are paid to the winning player, the residual bonus percentages that are paid to other players when the bonus is won, and which other players are to share in such residual bonus amounts. The odds of winning such bonuses may also be indicated. Such progressive table game bonus information can not only be stored within a particular bonus file within the database, but can also be retrieved and utilized by the progressive table game bonus server 170, as well as by the network 180 of one or more associated peripheral devices.

### Methods of Implementation

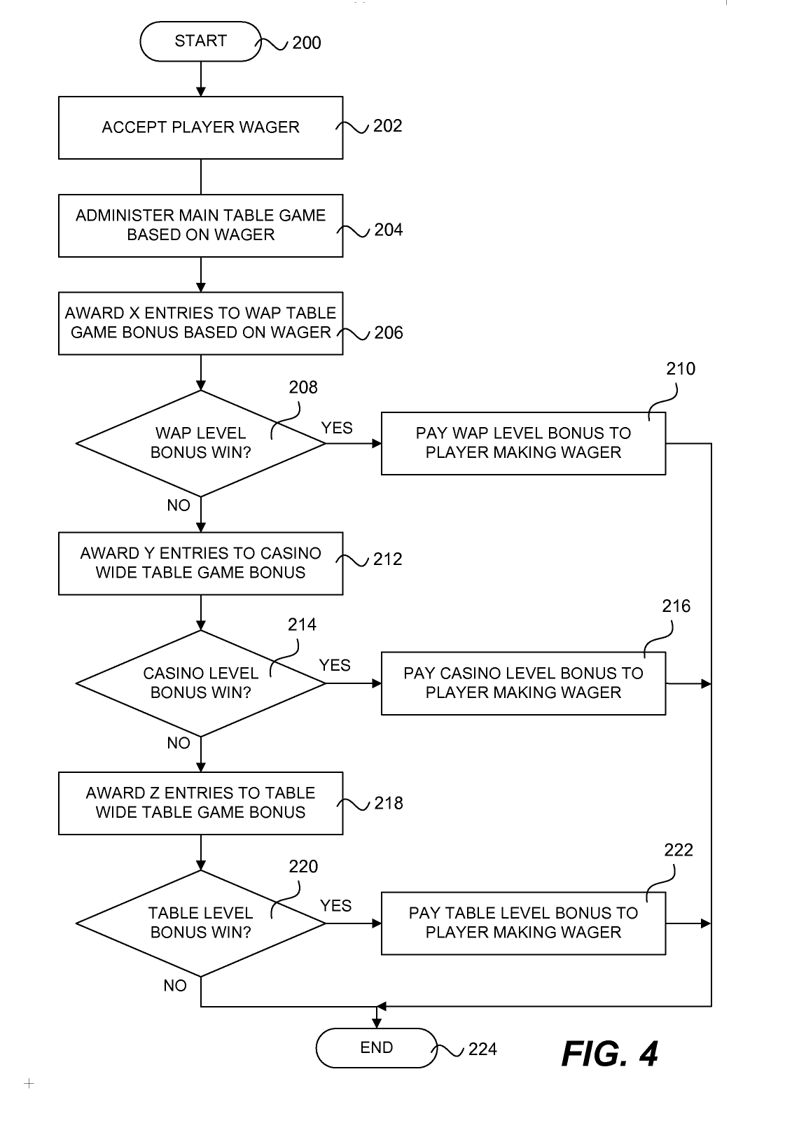

FIG. 4 depicts a flowchart of one exemplary method of providing a series of tiered progressive table game bonuses according to one embodiment of the present invention. While the provided flowchart may be comprehensive in some respects, it will be readily understood that not every step provided is necessary, that other steps can be included, and that the order of steps might be rearranged as desired by a given gaming operator. After start step 200, a player wager on a main table game is accepted at process step 202. In subsequent process step 204, a main table game is administered based on the accepted player wager. In some embodiments, this step 204 may come later than or be performed simultaneously with the following bonus determination steps 206-222. At process step 206, “X” number of entries to a top-level wide area progressive (“WAP”) table game bonus are awarded to the player based on the accepted wager. Various ways of determining exactly how many entries and/or the odds of such entries winning the bonus are disclosed above.

At decision step 208, an inquiry is made as to whether the player wins the WAP top-level bonus. If the WAP level bonus is won, then the method continues to process step 210, where the player is paid the WAP level bonus, after which the method ends at end step 224. If the WAP level bonus is not won, which is preferably the case in most instances, then the method continues to process step 212, where “Y” number of entries to a mid-level casino wide bonus are awarded to the player based on the accepted wager. Again, various ways of determining such entries are provided above. At following decision step 214, it is determined whether the casino mid-level bonus is won. If the casino level bonus is won, then the method similarly continues to process step 216, where the player is paid the casino level bonus, after which the method ends at end step 224. If the WAP bonus is not won, the method moves to process step 218, where “Z” number of entries to a lower-level single gaming table wide bonus are awarded to the player based on the accepted wager. At subsequent decision step 220, it is determined whether the single table lower-level bonus is won. If the single table level bonus is won, then the method similarly continues to process step 222, where the player is paid the single table level bonus, after which the method ends at end step 224. If the WAP bonus is not won, then no progressive bonus is won, and the method simply ends at end step 224.

It will be readily appreciated that other levels of bonuses may be included and/or substituted for the levels presented in this simplified illustrated example. Such additional levels could include a pit level bonus, a multi-pit level bonus, a multi-casino bonus and a worldwide bonus, among others. For each such level, method steps directed toward the awarding of entries, a bonus win determination and a bonus win payout can be added. Furthermore, while the illustrated method provides different bonus level determinations in series, it will also be appreciated that any or all such bonus level determinations could be made simultaneously or otherwise in parallel. Where level determinations are to be made in series, any order for levels can be chosen. In the present embodiment, it will be appreciated that a bonus win at any given level might then result in no determinations for the following levels. It is anticipated that this format of waiving lower levels would not be objectionable to most players, as a progressive bonus win at a higher level would typically be larger than, and thus more exciting and satisfying than, a bonus win at a lower level.

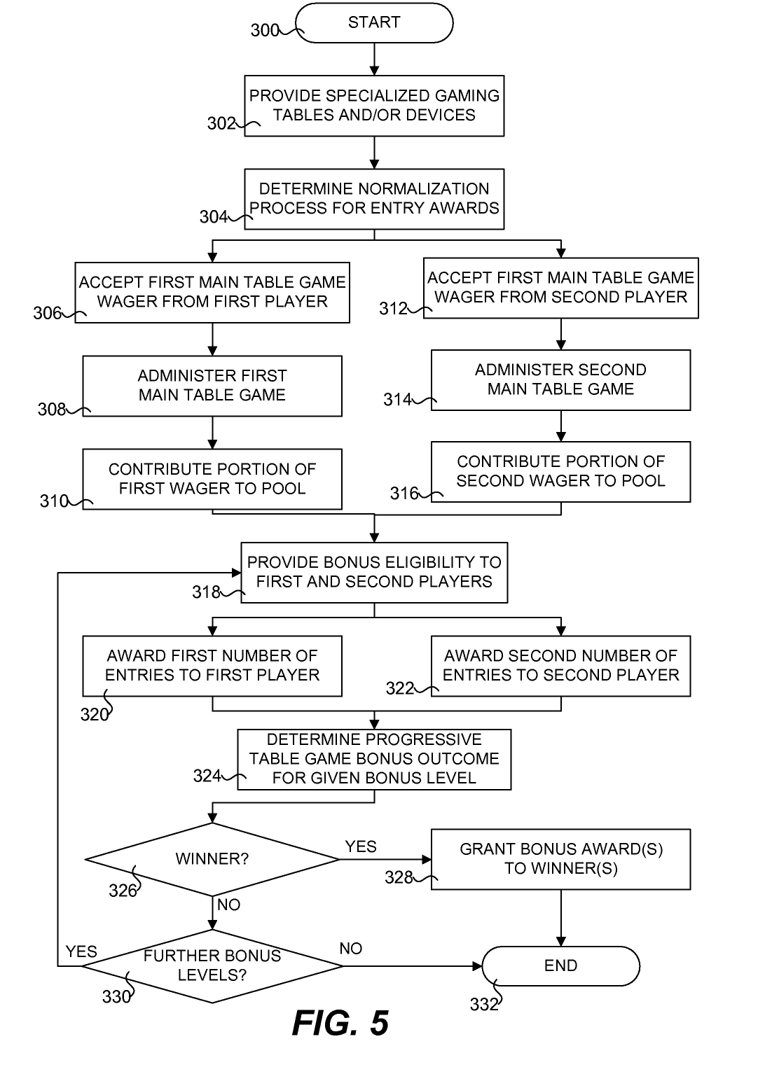

Turning next to FIG. 5, a flowchart illustrating one exemplary method of providing a common progressive table game bonus across multiple gaming tables providing disparate main table games according to one embodiment of the present invention is shown. Again, while the provided flowchart may be comprehensive in some respects, it will be readily understood that not every step provided is necessary, that other steps can be included, and that the order of steps might be rearranged as desired by a given gaming manufacturer, operator, retrofitter or repairperson. After start step 300, a plurality of specialized gaming tables and/or other relevant specialized gaming devices are provided at a process step 302. While such devices are preferably gaming tables having associated tracking devices, as discussed above, it will also be understood that such gaming devices could also be similar gaming tracking devices from alternative gaming environments that are adapted to host automated gaming events based on player wagers, the play of main or primary games based on the wagers, and the possible grant of awards, including monetary awards, based on the outcomes of the main games.

At process step 304, a normalization process for the awarding of bonus entries is determined. As noted above, such a normalization process can involve determining the lowest expectation value for the lowest possible wager at any gaming table that would be eligible to participate in the progressive table game bonus. Such a lowest expectation value minimum wager might be assigned, for example, one entry to a given progressive table game bonus determination. All other entry awards can then be based upon this normalization process, where any other wager that is of higher expectation value and/or greater monetary amount would receive a multiple number of bonus entries, with such a number correlating to the greater value of that wager with respect to the minimum expectation value and minimum monetary amount wager. In some embodiments, the base or normalized low number of entries for the lowest value wager might be more than one, such as where an incrementally higher value wager of a different type or at a different game might not be worth double or any multiple number of entries with respect to the base number. For example, where the base or normalized lowest expectation value wager is only slightly lower than the next lowest expectation value wager at an eligible table game, the base or lowest wager might be awarded three bonus entries, while the next lowest wager might be awarded four entries. All other wagers of higher expectation values and/or higher monetary amounts would then be granted a greater number of bonus entries as may be warranted. Of course, any provision where more entries are awarded based on such a normalization would then result in greater odds for any particular entry being able to win a particular progressive table game bonus.

At process step 306, a first main table game wager is accepted from a first patron at a first gaming table selected from the plurality of specialized gaming tables and/or other relevant gaming tracking devices. At subsequent process step 308, a first main table game based on the first wager is played or administered, with such a table game being identical or substantially similar to an ordinary table game for which no progressive table game bonus is available. As noted above, such a step for playing or administering the main table game may take place after the determination of a bonus or series of bonuses, as may be desired. At process step 310, a portion of the first main table game wager is contributed to the bonus or jackpot pool, with various ways of accomplishing this step being disclosed above. Before, during or after process steps 306-310 are being performed, similar process steps 312-316 are also performed. As shown, steps 312-316 similarly involve the acceptance of a second main table game wager from a second player at a second gaming table, the administering of a second main table game based on the second wager, and the contribution of a portion of the second main table game wager to the same bonus or jackpot pool. As noted above, such a second main table game can be of a type that is disparate with respect to the first main table tame. For example, the first table game could be blackjack, while the second table game could be craps or roulette.

At subsequent process step 318, eligibility to participate in the progressive table game bonus is provided to both the first and second players or patrons, which eligibility provision may be simultaneous. In process steps 320 and 322, numbers of entries to a provided progressive table game bonus level are then provided to both of the first and second players, after which a progressive table game bonus outcome for that given bonus level is then determined at process step 324. At subsequent decision step 326, an inquiry is made as to whether anyone has won the bonus. If so, then the method moves to step 328, where the pertinent bonus award or awards are granted to the winner(s), after which the method then ends at end step 332. If there is no winner of the progressive table game bonus at the given level, then the method continues to decision step 330, where an inquiry is made as to whether further progressive table game levels are available for the same first and second main table game wagers. If so, then the process reverts to step 318, where eligibility is provided to the players, and entry awards and bonus determinations can be made for the next given bonus level. If no further bonus level exists and no player has yet won a bonus, however, then the method ends at end step 332. Again, various details and additional steps may similarly be included, and it is specifically contemplated that many variations of these exemplary methods may also be practiced.

### Alternative Table Game Bonuses and Themes

In addition to the foregoing gaming table bonusing embodiments that are provided with respect to a relatively simple progressive gaming table bonus or serious of bonuses, further types of gaming table bonuses and bonus themes can also be provided to gaming table patrons. Such alternative table game bonuses can be provided in addition to or as part of an overall progressive gaming table bonus system, such as that which is provided herein.

One example of an alternative table game bonus can be a “Promotional Table Credit” bonus. Such a promotional table credit can involve the use of a special marker or chips that can be played at a gaming table as a regular wager, but cannot ever be exchanged for cash. As such, the promotional table credit object or objects must be wagered and played until they are lost. In the event that no loss occurs, such objects may be kept by the holding player for later. In some embodiments, such promotional table credit items may have expiration times or dates, while in others, such items may never expire, but can continue indefinitely until they are eventually lost. As a general example, a player might be given a $25 promotional table credit chip. The player could then wager this chip as if it were a real monetary value chip at any table game where such a real monetary value chip could be played. If the wager turns out to be a winning wager, the player would then be paid with real monetary value chips for the win. If the game were blackjack and the win was ordinary, for example, then the player could be paid for the win with an ordinary $25 real monetary value chip. If the wager turns out to be a losing wager, however, then the player simply loses the $25 promotional table credit chip.

In some embodiments, the promotional table credit would be taken by the casino or other gaming operator regardless of the game outcome, while in other embodiments, such promotional table credit would only be lost when the player loses the wager made with the promotional table credit. In the event of the latter, the player could continue to wager the promotional table credit repeatedly until it was lost, all the while collecting real monetary value chips as payment for all winning wagers with such promotional table credit. As will be readily appreciated, such promotional table credit can be awarded to players as one possible type of bonus award, and could also be provided to players as a form of player comp. A simple promotion might also be a way of providing promotional table credit to players. Some instances of such promotional table credit might be interchangeable between players, while others might be personal to a particular player or group of players. Where such promotional table credit is to be personal, a gaming operator might require the use of a player identifier, such as a player-tracking card.

Another alternative form of table game bonus can include the use of a “Scheduled Table Bounce Back.” Such a bonus is preferably available only to identified players and/or players being rated, and can be based on a form of percentage or “cashback” type of award correlating to a prescribed period of play and average bet level. Players who meet specified levels of play time and average bet levels can then be awarded with bonuses in the form of chips, promotional table credits, or a fixed prize such as a monetary prize and/or player comp at a time determined by the casino or other relevant gaming operator. Similarly, a “Table Point Play” in the form of an automated player tracking, player point accumulation and player point redemption can be provided. Players can earn player tracking points for table game play and redeem such player tracking points for chips, table credit and other prizes. Such tracking and awards can be fully automated, and/or may be made directly at gaming table, if desired.

Still another alternative form of table game bonus can be in the form of a “Lucky Chip” type bonus. Progressive “mystery” bonuses can be granted to a player betting a particularly designated “N” number of coin in, chip or cash equivalent on the casino floor over a given time period. For example, the millionth dollar or chip bet in a given week can qualify for a Lucky Chip bonus. Funding sources and parameters for such a bonus can be established by a given casino. As in the case of many other table game bonus awards provided herein, such Lucky Chip awards can vary between small and large awards. Lucky Chip can be facilitated with custom audio and video sequences to increase excitement and game play. Any number of games, including a whole pit or casino, can be associated with a specific bonus pool. As in the case of many other bonuses provided herein, Lucky Chip bonuses can be awarded to all players or just rated players.

In addition to a Lucky Chip type of bonus, a similar “Lucky Play Time” bonus might also be established. Table game player could qualify for such Lucky Play Time bonuses via rated play, and bonuses could be awarded in an automated, random and/or spontaneous fashion. As in the case of many of the bonuses provided herein, Lucky Play Time bonuses can also be awarded to all players or just rated players. Specific day and time parameter for bonus hits can be configured as desired by the casino or other gaming establishment, and funding sources can be designated as desired as well. For example, it is specifically contemplated that funding for a Lucky Play Time type of bonus be generated from the marketing budget of a casino, while funding for a Lucky Chip type of bonus be funded through a percentage of the hold on the actual bets or wagers made by players. Of course, alternative funding arrangements may also be used, such as the reverse of the foregoing being applied.

A related bonus to Lucky Chip and Lucky Play Time can involve an “All-In Prizes” type of bonus. Under such an arrangement, an automated mechanism can be established for rewarding many players with chips or Promotional Table Credit when a Lucky Chip or Lucky Play Time jackpot or bonus is won. For example, every eligible player can receive a portion of a bonus pool award when such a bonus is won. Such an arrangement is similar in nature to embodiments provided above for the universal progressive table game bonus, such as where a primary winner receives 80% or some other large portion of the jackpot prize pool, and all other eligible players then split the remainder of the pool. In this manner, every eligible player is allowed to share in the excitement and reward of the jackpot being won.

Yet another alternative form of table game bonus can include a “Blackjack Bonanza” bonus, which bonus can be awarded to the player hitting a designated number “Nth” blackjack. Another alternative table game bonus can involve a “Multiple Bet Time” or “Multiplier” bonus, where a given eligible bet or wager can be multiplied by a factor for purposes of participating in the progressive table game bonus. For example, a 10× Multiplier bonus might be randomly applied to a given main game wager to result in ten times the normal number of progressive table game bonus entries being awarded to the respective player for that wager. In some embodiments, a Multiple Bet Time might be provided when a particular bonus or jackpot pool reaches a predetermined level, and such a Multiple Bet Time might continue until the jackpot has been won or the bonus or jackpot pool is depleted.

Further alternative forms of table game bonuses can include “Private Jackpots,” where individualized progressive bonus award amounts are provided for selected VIPs and club members, and only these players can win these Private Jackpots. Private Jackpot amounts and pools can grow as the preferred patron or a pool of preferred patrons continue to play and fund these preferred jackpot pools. A Private Jackpot award can be triggered in any of a number of ways, such as, for example, when the actual private jackpot pool hits a specific mystery value that lies between a pre-set range of values.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A gaming system adapted for providing bonuses at gaming tables hosting gaming events involving the placement of wagers, the play of main games based on the wagers and the grant of monetary payouts based on the results of the main games, the gaming system comprising:
a first gaming table adapted for hosting gaming events involving a wager, the play of a first main table game based on the wager and the grant of a payout based on the result of said first main table game, said first gaming table having a first surface adapted for the play of said first main table game and a first gaming table tracking device adapted to facilitate the tracking of gaming events associated with a first patron playing at said first gaming table;
a second gaming table separate from said first gaming table and adapted for hosting gaming events involving a wager, the play of a second main table game based on the wager and the grant of a payout based on the result of said second main table game, said second gaming table having a second surface adapted for the play of said second main table game and a second gaming table tracking device adapted to facilitate the tracking of gaming events associated with a second patron playing at said second gaming table, wherein said second main table game is a disparate type of game from said first main table game; and
a progressive table game bonus server in direct or indirect communication with said first gaming table tracking device and said second gaming table tracking device, said progressive table game bonus server being adapted to
track specific gaming activities at both of said first gaming table and said second gaming table,
provide eligibility to a singular progressive table game bonus both to said first patron based on the play of said first main table game at said first gaming table and also to said second patron based on the play of said second main table game at said second gaming table, and
determine a progressive table game bonus outcome based on said specific gaming activities and said provided player eligibilities.

2. The gaming system of claim 1, wherein said progressive table game bonus server is further adapted to determine a progressive table game bonus outcome based on a result provided from an associated random number generator.

3. The gaming system of claim 1, wherein said progressive table game bonus server is further adapted to provide eligibility to said singular progressive table game bonus to said first patron based solely on a main wager made by said first patron on the play of said first main table game.

4. The gaming system of claim 3, wherein said progressive table game bonus server is further adapted to provide eligibility to said singular progressive table game bonus to said second patron based solely on a main wager made by said second patron on the play of said second main table game.

5. The gaming system of claim 1, wherein said progressive table game bonus server is further adapted to determine a progressive table game bonus outcome for each associated gaming table asynchronously with respect to the gaming activities of every other associated gaming table.

6. The gaming system of claim 1, wherein said progressive table game bonus server is further adapted to determine all table game patrons eligible for said singular progressive table game bonus, to track wagering information with respect to each said eligible table game patron, to award an appropriate number of entries to said singular progressive table game bonus to each said eligible table game patron based on said wagering information for each said eligible table game patron, and to grant a singular progressive table game bonus award based at least in part on said appropriate number of bonus entries assigned to each said eligible table game patron.

7. The gaming system of claim 6, wherein said progressive table game bonus server is further adapted to award at least a portion of said entries to said singular progressive table game bonus based on expectation values associated with table game wagers made by said table game patrons.

8. The gaming system of claim 6, wherein said progressive table game bonus server is further adapted to award a first number of entries to said singular progressive table game bonus to said first patron based upon a first wager having a first monetary value made by said first patron, and also to award a second number of entries to said singular progressive table game bonus to said second patron based upon a second wager having a second monetary value made by said second patron, wherein said first and second monetary values are equal, and wherein said first and second number of entries are not equal.

9. The gaming system of claim 8, wherein said disparate number of entries awarded to said singular progressive table game bonus are not made on the basis of the identity of either of said first or second patrons.

10. The gaming system of claim 8, wherein said disparate number of entries awarded to said singular progressive table game bonus are made on the basis of different expectation values with respect to said first wager and said second wager.

11. The gaming system of claim 1, wherein said progressive table game bonus server is further adapted to award said entries on a normalized basis.

12. The gaming system of claim 11, wherein said normalized basis includes a determination of the lowest expectation value possible with respect to an eligible gaming table wager on an eligible gaming table.

13. The gaming system of claim 1, wherein said singular progressive table game bonus comprises a jackpot pool.

14. The gaming system of claim 13, wherein the size of at least one bonus award made from singular progressive table game bonus is based on the size of said jackpot pool at the time said bonus award is made.

15. The gaming system of claim 13, wherein said progressive table game bonus server is further adapted to fund said jackpot pool from portions of main game wagers made on respective main table games.

16. The gaming system of claim 15, wherein said portions of main game wagers used to fund said jackpot pool correspond to respective expectation values of said main game wagers.

17. The gaming system of claim 16, wherein said progressive table game bonus server is further adapted to award additional entries to said singular progressive table game bonus based upon one or more factors selected from the group consisting of increased wager amounts, increased wager expectation values and sustained expectation values for players over a period of time.

18. The gaming system of claim 1, wherein said progressive table game bonus server is further adapted to determine said progressive table game bonus outcome randomly and without respect to the outcome of any main table game.

19. The gaming system of claim 1, wherein said progressive table game bonus server is further adapted to determine a winning outcome as an outcome for said progressive table game bonus outcome, with said winning outcome resulting in a bonus monetary grant to at least one patron.

20. The gaming system of claim 19, wherein said winning outcome results in a simultaneous bonus monetary grant to a plurality of patrons.

21. The gaming system of claim 1, wherein said progressive table game bonus server is further adapted to provide eligibility to said singular progressive table game bonus only to patrons playing with player tracking identifiers.

22. The gaming system of claim 1, wherein said progressive table game bonus server is further adapted to provide eligibility to a plurality of tiered progressive table game bonuses to said first patron.

23. The gaming system of claim 22, wherein at least two of said plurality of tiered progressive table game bonuses are selected from the group consisting of a single table bonus, a pit area bonus, a casino wide bonus, a wide area bonus including multiple casinos, an entire region bonus including a large number of casinos, and a worldwide bonus.

24. A method of providing a progressive table game bonus, comprising:
providing a plurality of gaming tables adapted for hosting gaming events involving wagers, the play of main table games based on said wagers and the grant of monetary payouts based on the result of said main table games, said plurality of gaming tables each having a surface adapted for the play of said main table games and gaming table tracking devices adapted to facilitate the tracking of gaming events associated with patrons playing at said plurality of gaming tables;
accepting a first main table game wager from a first patron at a first gaming table selected from said plurality of gaming tables;
administering a first main table game at said first gaming table, said first main table game involving said first main table game wager;
contributing a portion of said first main table game wager to a progressive table game bonus jackpot pool;
accepting a second main table game wager from a second patron at a second gaming table selected from said plurality of gaming tables;
administering a second main table game at said second gaming table, said second main table game involving said second main table game wager, wherein said second main table game is a disparate type of game from said first main table game;
contributing a portion of said second main table game wager to said progressive table game bonus jackpot pool;
providing eligibility to win the same progressive table game bonus both to said first patron based on said first main table game wager and to said second patron based on said second main table game wager; and
determining a first progressive table game bonus outcome.

25. The method of claim 24, wherein the type of said first main table game and the type of said second main table game are both selected from the group consisting of poker, blackjack, baccarat, craps, roulette, pai-gow, Carribean Stud, Spanish 21, and Let It Ride.

26. The method of claim 24, wherein said step of providing eligibility to win the same progressive table game bonus both to said first patron and to said second patron is based only on said first and second main table game wagers.

27. The method of claim 24, further including the steps of:
determining a normalization process for the awarding of entries to said progressive table game bonus;
awarding a first number of entries to said progressive table game bonus to said first patron based on said first main table game wager and said normalization process;
awarding a second number of entries to said progressive table game bonus to said second patron based on said second main table game wager and said normalization process; and
granting a progressive table game bonus award based at least in part on said appropriate number of bonus entries assigned to each said eligible table game patron.

28. The method of claim 24, wherein said first progressive table bonus outcome is based upon a first level bonus, and further including the step of:
determining a second progressive table game bonus outcome, said second progressive table bonus outcome being based upon a second level bonus, wherein said second level bonus is based upon a subset of gaming tables from all gaming tables upon which said first level bonus is based.

29. A progressive table game bonus server adapted for use in a gaming environment, comprising:
a first communication link to a first gaming table tracking device, said first gaming table tracking device being associated with a first gaming table adapted for the play of a first main table game involving a wager, the play of a game based on the wager and the grant of a payout based on the result of the game, wherein said first gaming table tracking device is adapted to track gaming events relating to said first main table game that take place on said first gaming table;
a second communication link to a second gaming table tracking device, said second gaming table tracking device being associated with a second gaming table adapted for the play of a second main table game involving wagers, the play of a games based on the wagers and the grant of monetary payouts based on the results of the games, wherein said second gaming table tracking device is adapted to track gaming events relating to said second main table game that take place on said second gaming table, wherein said second main table game is a disparate type of game from said first main table game; and
a processing component coupled to said first communication link and said second communication link and adapted to
track specific gaming activities at each of said first gaming table and said second gaming table,
provide eligibility to win a singular progressive table game bonus to one or more patrons at each of said first gaming table and said second gaming table based on the play of said first main table game at said first gaming table and the play of said second main table game at said second gaming table, and
determine a progressive table game bonus outcome based on said specific gaming activities and said provided player eligibilities.

30. The progressive table game bonus server of claim 29, wherein the type of said first main table game and the type of said second main table game are both selected from the group consisting of poker, blackjack, baccarat, craps, roulette, pai-gow, Carribean Stud, Spanish 21, and Let It Ride.

31. The progressive table game bonus server of claim 29, wherein said processing component is adapted to provide eligibility to win said singular progressive table game bonus to patrons based only on main table game wagers.

32. A gaming system adapted for providing bonuses at one or more gaming tables hosting gaming events involving the placement of wagers, the play of main games based on the wagers and the grant of monetary payouts based on the results of the main games, the gaming system comprising:
one or more gaming tables adapted for hosting gaming events involving a wager, the play of a main table game based on the wager and the grant of a payout based on the result of said main table game, said one or more gaming tables each having a surface adapted for the play of said main table game and one or more gaming table tracking devices adapted to facilitate the tracking of gaming events associated with a plurality of patrons playing at said one or more gaming tables; and
a progressive table game bonus server in direct or indirect communication with said one or more gaming table tracking devices, said progressive table game bonus server being adapted to
track specific gaming activities with respect to each of said plurality of patrons at each of said one or more gaming tables,
provide eligibility to a singular progressive table game bonus to each of said plurality of patrons based only on the play of main table games at said one or more gaming tables, and
determine a progressive table game bonus outcome based on said specific gaming activities and said provided player eligibilities.
